(19) United States
(12) Patent Application Publication
(10) Pub. No.: US 2012/0131966 A1
(43) Pub. Date: May 31, 2012

(54) Apparatus for Locking a Saddle Post of to a Seat Tube of a Bicycle

(76) Inventor: Zuo-Rong YUAN, Taichung City (TW)

(21) Appl. No.: 13/302,093

(22) Filed: Nov. 22, 2011

(30) Foreign Application Priority Data
Nov. 26, 2010 (TW) 099223052

(51) Int. Cl. B62K 19/36; E05B 67/00; E05B 71/00

(52) U.S. Cl. 70/233; 403/322.4

(57) ABSTRACT

Disclosed is an apparatus for locking a saddle post to a seat tube. The saddle post is movably inserted in the seat tube. The apparatus includes a quick release clamp and a lock. The quick release clamp includes a ferrule, a lug and a handle. The ferrule is provided around the seat tube. The lug is formed on the ferrule. The handle is operable to tighten the ferrule on the seat tube. The handle includes a slot defined therein. The lock includes a portion that can be inserted through the lug after the lug is inserted though the slot defined in the handle.

### BACKGROUND OF INVENTION

1. Field of Invention

The present invention relates to a bicycle and, more particularly, to an apparatus for locking a saddle post to a seat tube of a bicycle.

2. Related Prior Art

Referring to FIG. 1, there is shown a bicycle. The bicycle includes a frame 10 and a saddle 15. The frame 10 includes a seat tube 11. The saddle 15 is supported on a saddle post 16. The saddle post 16 is movably inserted in the seat tube 11. A quick release clamp 13 is used to position the saddle post 16 and hence the saddle 15 relative to the seat tube 11. The quick release clamp 13 includes a ferrule 12 and a handle 14. The handle 14 can be operated to tighten the ferrule 12 around the seat tube 11. Thus, the ferrule 12 causes the seat tube 11 to clamp 13 the saddle post 16 so that the saddle 15 is positioned relative to the seat tube 11. The saddle 15 could however be stolen by operating the handle 14 with bare hands easily.

### SUMMARY OF INVENTION

It is the primary objective of the present invention to an apparatus for locking a saddle post to a seat tube of a bicycle.

To achieve the foregoing objective, the apparatus includes a quick release clamp and a lock. The quick release clamp includes a ferrule, a lug and a handle. The ferrule is provided around the seat tube. The lug is formed on the ferrule. The handle is operable to tighten the ferrule on the seat tube. The handle includes a slot defined therein. The lock includes a portion that can be inserted through the lug after the lug is inserted though the slot defined in the handle.

### BRIEF DESCRIPTION OF DRAWINGS

The present invention will be described via illustration of two embodiments versus the prior art referring to the drawings wherein:

FIG. 1 is partial, perspective view of a conventional bicycle;

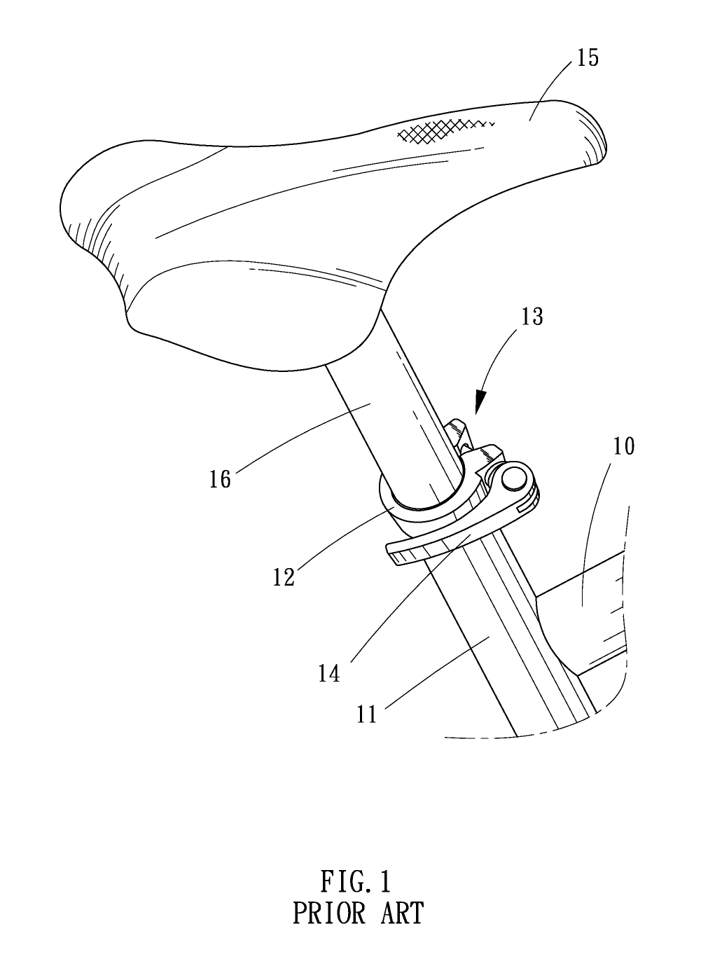

FIG. 2 is a partial, perspective view of a bicycle equipped with an apparatus for locking a saddle post to a seat tube according to the first embodiment of the present invention; and

FIG. 3 is a partial, perspective view of a bicycle equipped with an apparatus for locking a saddle post to a seat tube according to the second embodiment of the present invention.

### DETAILED DESCRIPTION OF EMBODIMENTS

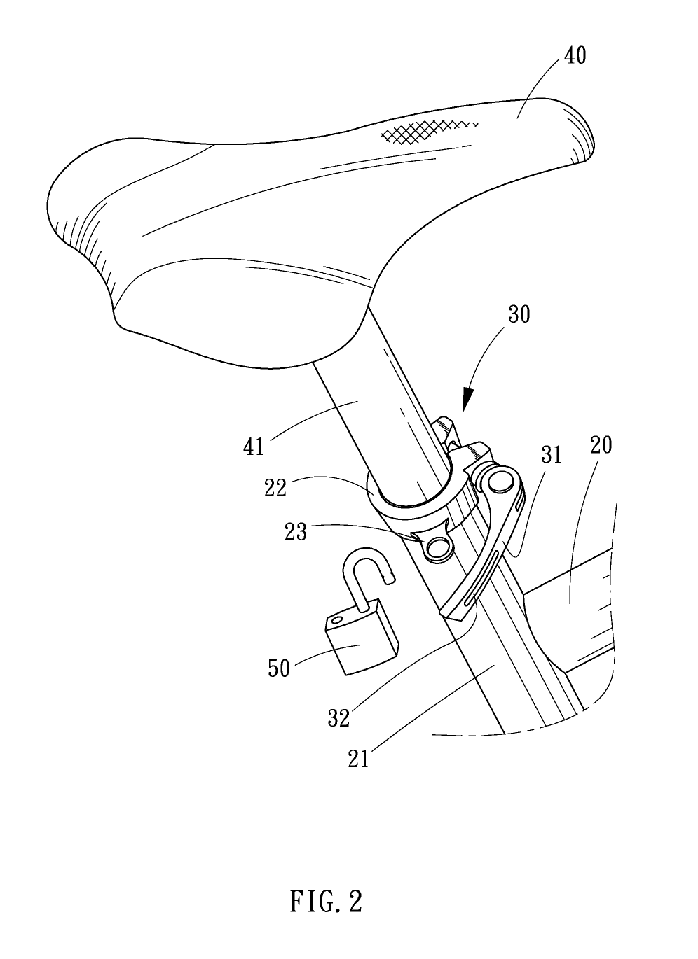

Referring to FIG. 2, there is shown a bicycle equipped with a locking apparatus according to a first embodiment of the present invention. The bicycle includes a frame 20 and a saddle 40. The frame 20 includes a seat tube 21 formed thereon. The saddle 40 is supported on a saddle post 41. The saddle post 41 is movably inserted in the seat tube 21 so that the position of the saddle post 41 relative to the seat tube 21 is adjustable. Accordingly, the position of the saddle 40 relative to the seat tube 21 is adjustable.

The locking apparatus includes a quick release clamp 30 and a pad lock 50. The quick release clamp 30 includes a ferrule 22, a lug 23 and a handle 31. The ferrule 22 is provided around seat tube 21. The handle 31 is connected to the ferrule 22. The handle 31 is operable to tighten the ferrule 22 around the seat tube 21. Thus, the ferrule 22 causes the seat tube 21 to clamp 30 the saddle post 41 so that the saddle 40 is positioned relative to the seat tube 21.

The lug 23 is formed on the ferrule 22. The lug 23 includes an aperture defined therein. The handle 31 includes a slot 32 defined therein. The pad lock 50 includes a shackle. The lug 23 is inserted through the slot 32 after the saddle post 41 is firmly positioned relative to the seat tube 21 by the quick release clamp 30. The shackle of the pad lock 50 is inserted through the aperture of the lug 23. Thus, the handle 31 is locked to the lug 23 by the pad lock 50. Now, the handle 31 cannot be operated to loose the grip of the ferrule 22 on the seat tube 21 and the grip of the seat tube 21 on the saddle post 41. That is, the saddle post 41 is locked to the seat tube 21, and so is the saddle 40.

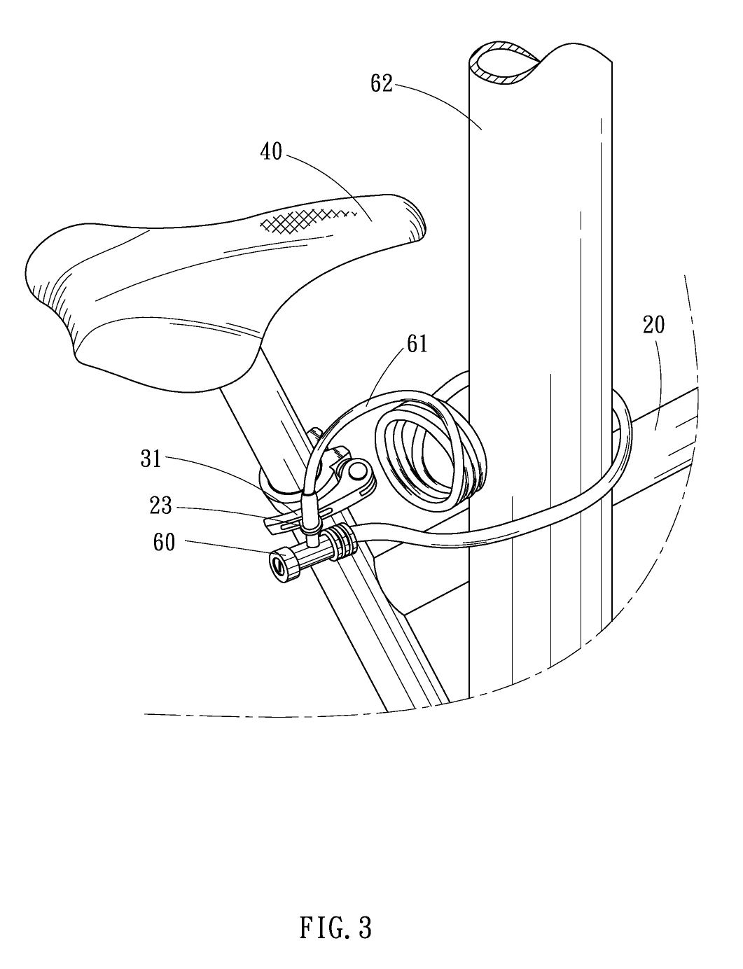

Referring to FIG. 3, there is shown a locking apparatus according to a second embodiment of the present invention. The second embodiment is identical to the first embodiment except for including a cable lock 60 instead of the pad lock 50. The cable lock 60 includes a cable 61. A first end of the cable 61 is secured to the cable lock 60. A second end of the cable 61 can be locked in and removed from the cable lock 60. The second end of the cable 61 is locked in the cable lock 60 after it is inserted through the aperture of the lug 23. Thus, the saddle post 41 is locked to the seat tube 21, and so is the saddle 40. Furthermore, the cable 61 is wound around an object 62 secured to the ground so that the bicycle is locked to the object 62. The object 62 may be a lamp post, a rail or a trunk of a tree for example.

1. An apparatus for locking a saddle post to a seat tube, wherein the apparatus includes:
a quick release clamp including:
a ferrule provided around the seat tube;
a lug formed on one of the seat tube and the ferrule; and
a handle operable to tighten the ferrule on the seat tube, wherein the handle includes a slot defined therein; and
a lock includes a portion that can be inserted through the lug after the lug is inserted though the slot defined in the handle.

2. The apparatus according to claim 1, wherein the lug is formed on the ferrule.

3. The apparatus according to claim 1, wherein the lock is a pad lock.

4. The apparatus according to claim 1, wherein the lock is a cable lock.
